(19) United States
(12) Patent Application Publication
(10) Pub. No.: US 2008/0110215 A1
(43) Pub. Date: May 15, 2008

(54) Device for locking a door

(76) Inventors: Karapet Gyurdzhyan, Los Angeles, CA (US); Jirayr Gyurjyan, Los Angeles, CA (US)

Correspondence Address: TOPE-MCKAY & ASSOCIATES, 23852 PACIFIC COAST HIGHWAY #311, MALIBU, CA, 90265, US

(21) Appl. No.: 11/983,574

(22) Filed: Nov. 9, 2007

Related U.S. Application Data
(60) Provisional application No. 60/857,935, filed on Nov. 9, 2006.

(51) Int. Cl. E05B 73/00; F21V 33/00

(52) U.S. Cl. 70/15; 362/109

(57) ABSTRACT

A device for locking a door is described. The device includes an elongated rod having a latch attachment. The latch attachment is of a suitable size and shape to accommodate a variety of door lock mechanism. Thus, a user can position the latch attachment over a turning latch of a door lock mechanism and position the elongated rod against a door handle to prevent the lock from being unlocked. An attachment mechanism is also included for attaching the device with a door handle when not in use.

### PRIORITY CLAIM

The present application is a non-provisional patent application, claiming the benefit of priority to U.S. Provisional Application No. 60/857,935, filed in the United States on Nov. 9, 2006, titled, “Club for Locking a Door.”

### BACKGROUND OF THE INVENTION

(1) Field of Invention

The present invention relates to a door lock device and, more particularly, to a device that can be affixed with a user's door for securing the door's existing locking mechanism.

(2) Description of Related Art

Door locks have long been known in the art. Such locks were devised to secure a door and prevent intruders or other outsiders from passing through the door. A commonly used door lock is a traditional door handle-based lock. A handle-based lock uses a locking mechanism that is built into the door handle to prevent the door handle from turning. In addition to door handle-based locks, deadbolts are often used to lock a door. Deadbolts are used to slide a pin into the door frame and further secure the door against unwanted openings. A problem with deadbolts is that they can be picked or otherwise opened by individuals having a key to the deadbolt.

Although many people do not allow strangers or others to have an extra key to their deadbolt, this is not always the case. Additionally, in some circumstances, it may be difficult to control who has an extra key. For example, in rental situations, it is common to use the same locks that a previous tenant used. While a resident can simply change the locks upon moving into the residence, this is not always feasible.

Thus, a continuing need exists for a device to allow a user to secure a deadbolt that prevents outsiders and intruders from unlocking the deadbolt, with or without a key.

### SUMMARY OF THE INVENTION

The present invention relates to a device for locking a door. The device comprises an elongated rod with a latch attachment disposed on the elongated rod. The latch attachment is formed to be attached with a turning latch of a door lock mechanism. Thus, a user can attach the latch attachment with the door lock mechanism and position the elongated rod against a door handle to prevent the lock from being unlocked.

In another aspect, an attachment mechanism is affixed with the device for attaching the device with a door when not in use.

In yet another aspect, a flashlight mechanism is disposed within the elongated rod.

Additionally, a soft pad is circumferentially disposed around the elongated rod.

In yet another aspect, the latch attachment is a cut-out formed within the elongated rod. The cut-out is of a suitable size and shape to accommodate a turning latch of the door lock mechanism. Thus, a user can position the cut-out over the turning latch and position the elongated rod against a door handle to prevent the lock from being unlocked.

In another aspect, the latch attachment further comprises a hook device for attaching the latch attachment with the door lock mechanism. Additionally, an opening is formed through the latch attachment to allow the turning latch to fit through the opening.

In another aspect, an adjustment mechanism is attached with the elongated rod. The adjustment mechanism is formed to allow a user to selectively tighten the latch attachment against the turning latch.

The adjustment mechanism further comprises an inner rod slidably connected with the elongated rod and a positioning device connected with the inner rod to allow the inner rod to be selectively affixed with the elongated rod.

In another aspect, the adjustment mechanism further comprises a notched bar attached with the elongated rod and a positioning device formed to interact with the notched bar and connect the latch mechanism to the elongated rod. The positioning device is formed to allow a user to slideably adjust the latch attachment along the elongated rod.

As can be appreciated by one in the art, the present invention also comprises a method for forming and using the device described herein. The method for forming the device includes a plurality of acts of forming, attaching, connecting, etc., each of the described components to arrive at the present invention. Finally, the method for using the device includes a plurality of acts of affixing the device with a door lock mechanism as described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1A is an illustration of a device according to the present invention, depicting the device as being formed of a cylindrical rod;

FIG. 1B is an illustration of a device according to the present invention, depicting the device as being formed of a cylindrical rod;

FIG. 2A is an illustration of a device according to the present invention, depicting the device as being formed of a rectangular rod;

FIG. 2B is an illustration of a device according to the present invention, depicting the device as being formed of a rectangular rod;

FIG. 3A illustrates a turning latch mechanism of a deadbolt in an unlocked position;

FIG. 3B illustrates a turning latch mechanism of a deadbolt in a locked position;

FIG. 4A is an illustration of a device according to the present invention, illustrating the device positioned aside a door with a turning latch mechanism of a deadbolt in a locked position;

FIG. 4B is an illustration of a device according to the present invention, illustrating the device positioned over a locked turning latch mechanism of a deadbolt so that it rests against a door handle when the turning latch mechanism of the deadbolt and the door handle are located on the left side of a door;

FIG. 4C is an illustration of a device according to the present invention, illustrating the device positioned over a locked turning latch mechanism of a deadbolt so that it rests against a door handle when the turning latch mechanism of the deadbolt and the door handle are located on the right side of a door;

FIG. 5A is an illustration of the various parts of the device according to the present invention, illustrating an elongated rod with latch attachment, soft pad, attachment mechanism, and flashlight mechanism;

FIG. 5B is an illustration of the device according to the present invention, depicting the device with a soft pad, attachment mechanism, and flashlight mechanism;

FIG. 5C is an illustration of the device according to the present invention, depicting a side, perspective-view of the device with a soft pad, attachment mechanism, and flashlight mechanism;

FIG. 5D is an illustration of the device according to the present invention, depicting a front, perspective-view of the device with a soft pad, attachment mechanism, and flashlight mechanism;

FIG. 6A is an illustration of the various parts of the device according to the present invention, illustrating an elongated rod, protective cap, soft pad, latch attachment with hook device, and adjustment mechanism;

FIG. 6B is an illustration of the device according to the present invention, depicting the device with a soft pad, protective cap, latch attachment, and adjustment mechanism;

FIG. 6C is an illustration of the device according to the present invention, depicting a side, perspective-view of the device with a soft pad, protective cap, latch attachment, and adjustment mechanism;

FIG. 6D is an illustration of the device according to the present invention, depicting a back perspective-view of the device with a soft pad, protective cap, latch attachment, and adjustment mechanism;

FIG. 7A is an illustration of the various parts of the device according to the present invention, illustrating an elongated rod, soft pad, latch attachment with hook device, adjustment mechanism, and flashlight mechanism;

FIG. 7B is an illustration of the device according to the present invention, depicting the device with a soft pad, latch attachment, adjustment mechanism, and flashlight mechanism;

FIG. 7C is an illustration of the device according to the present invention, depicting a side, perspective-view of the device with a soft pad, latch attachment, adjustment mechanism, and flashlight mechanism; and

FIG. 7D is an illustration of the device according to the present invention, depicting a back perspective-view of the device with a soft pad, latch attachment, adjustment mechanism, and flashlight mechanism.

### DETAILED DESCRIPTION

The present invention relates to a door lock device and, more particularly, to a device that can be affixed with a user's door for securing the door's existing locking mechanism. The following description is presented to enable one of ordinary skill in the art to make and use the invention and to incorporate it in the context of particular applications. Various modifications, as well as a variety of uses, in different applications will be readily apparent to those skilled in the art, and the general principles defined herein may be applied to a wide range of embodiments. Thus, the present invention is not intended to be limited to the embodiments presented, but is to be accorded with the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object. As such, as the present invention is changed, the above labels may change their orientation.

(1) Description

The present invention relates to a door lock device. The device is used for attaching with a turning latch mechanism of a lock to ensure that the lock cannot be unlocked from outside, even with the use of a key. As can be appreciated by one skilled in the art, the device can be attached with any type of lock that includes a turning latch mechanism, a non-limiting example of which includes a deadbolt lock.

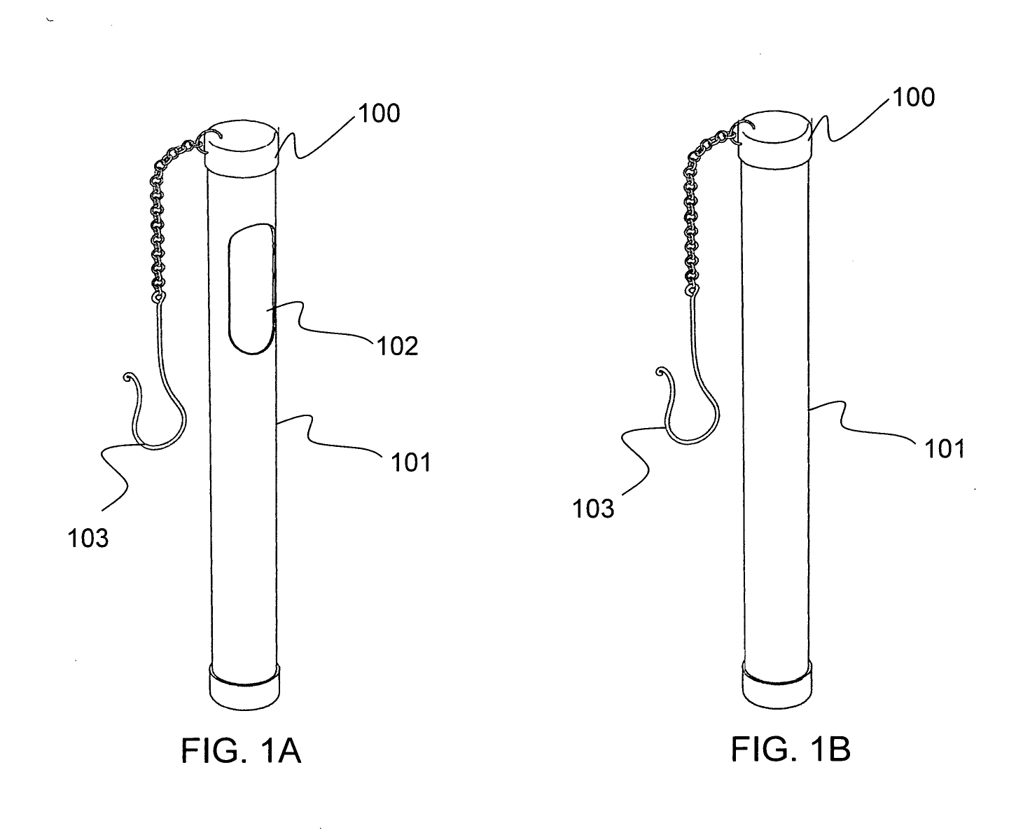

FIG. 1A illustrates a door lock device 100 formed of an elongated rod 101, a non-limiting example of which includes a cylindrical rod. As can be appreciated by one skilled in the art, the present invention is not limited to an elongated rod, so long as it is an elongated device that can be affixed with a lock's turning latch mechanism and wedged against a door's door handle to prevent the turning latch mechanism from turning. To attach with the turning latch mechanism, the door lock device 100 includes a latch attachment 102 that is disposed along the elongated rod 101. The latch attachment 102 is any suitable mechanism, device, or configuration that allows the door lock device 100 to be affixed with a door lock's turning latch mechanism. As a non-limiting example, the elongated rod 101 is hollowed out in order to provide a space therein. In other words and as illustrated in FIG. 1A, the latch attachment 102 can be a cut-out in the elongated rod 101 that is formed to be positioned over the turning latch mechanism of a lock. In this aspect, the cut-out of the latch attachment 102 can be any suitable size or shape to accommodate a turning latch mechanism of a lock. Thus, the cut-out is formed to be positioned over the turning latch mechanism such that the turning latch mechanism is positioned within the cut-out. An attachment mechanism 103 is provided on the device 100 to allow a user to hang the device 100 from a door handle, lock, or any preferred location when not in use. A non-limiting example of such an attachment mechanism 103 is a hook. For further illustration, FIG. 1B illustrates another perspective of the device 100.

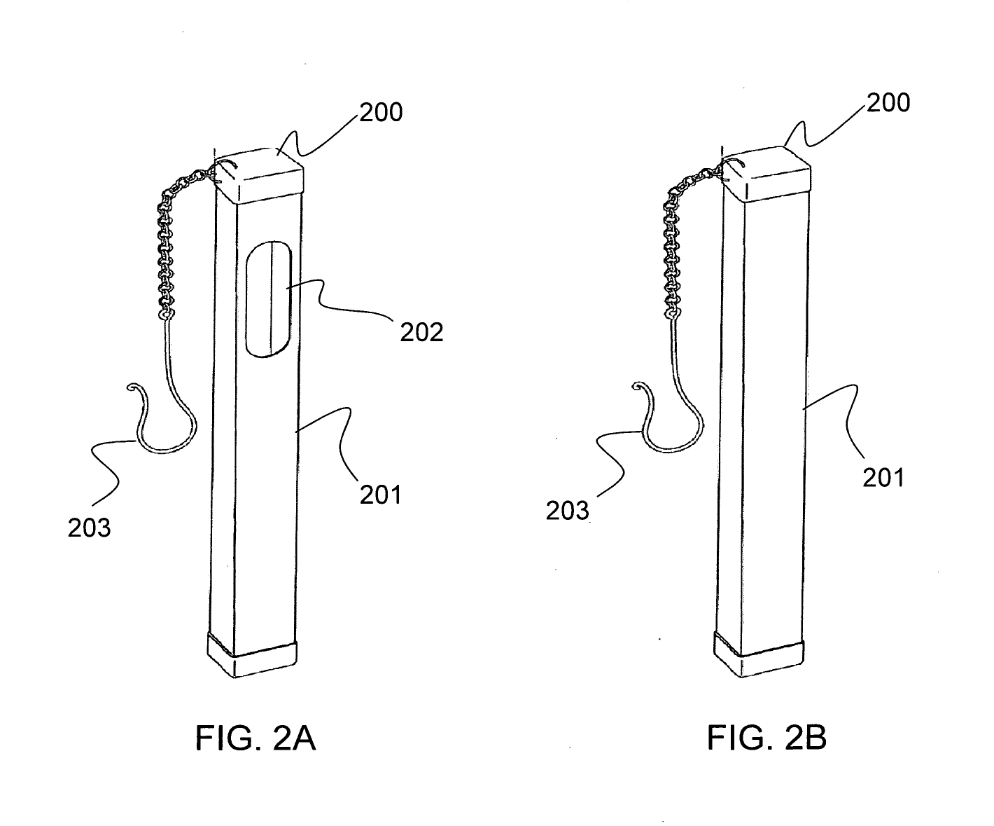

FIG. 2A illustrates a door lock device 200 formed of an elongated rectangular rod 201, including a latch attachment 202 (e.g., cut-out) and attachment mechanism 203. As can be appreciated by one skilled in the art, the device 200 is not limited to any particular shape or material provided it is elongated sufficiently to perform its designated function. For further illustration, FIG. 2B illustrates the device 200 from another perspective.

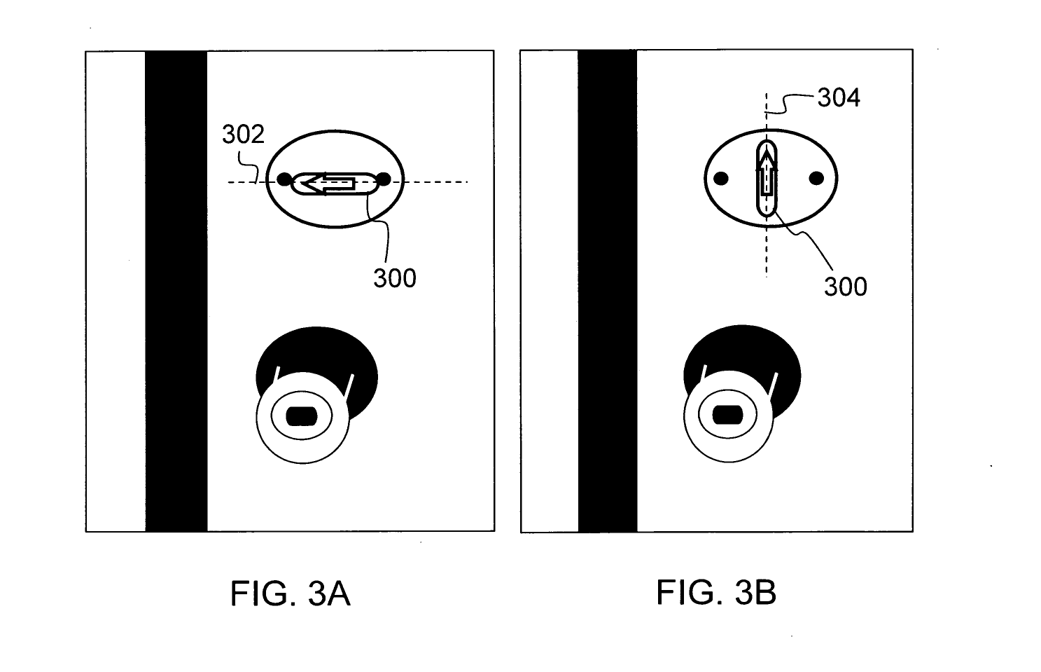

To provide the reader with a better understanding of the present invention, FIGS. 3A and 3B depict a turning latch 300 of a door lock mechanism in an unlocked position 302 and locked position 304, respectively. A non-limiting example of such a turning latch 300 is the latch that is commonly used to lock/unlock a deadbolt lock. In operation, the device can be positioned over the turning latch 300 of a door lock mechanism when it is in the locked position 304, as illustrated in FIG. 3B.

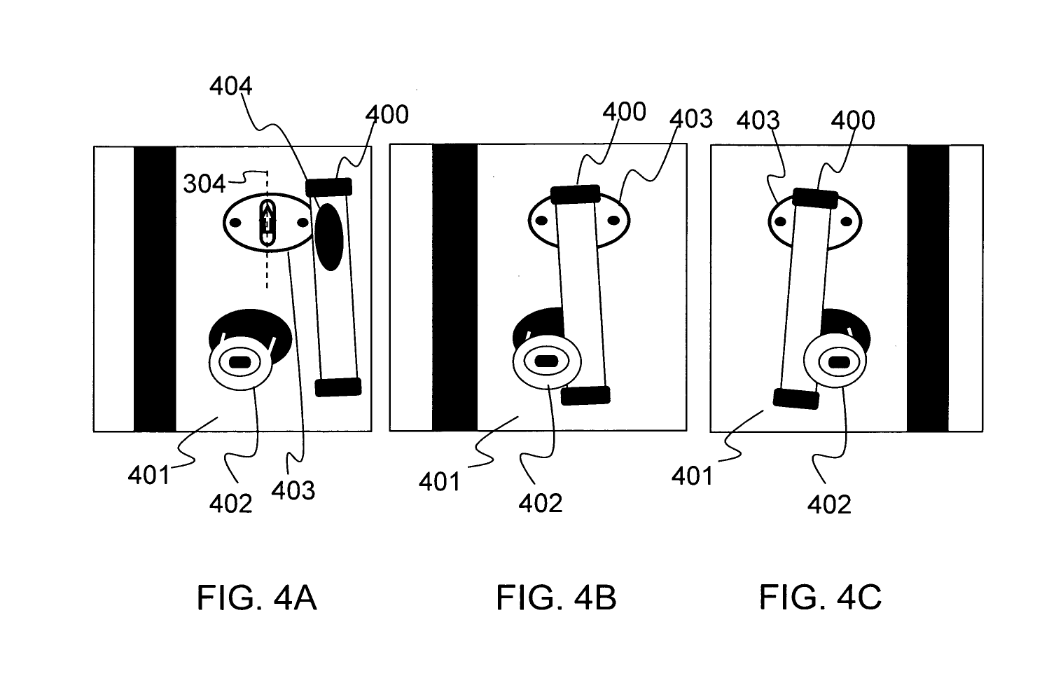

FIGS. 4A through 4C illustrate the device 400 in operation. FIG. 4A illustrates the device 400 positioned aside a door 401 with a door handle 402 and a turning latch mechanism 403 of a deadbolt in a locked position 304. As shown, the device 400 includes a space therein, or cut-out 404 (i.e., latch attachment), that can be positioned over the deadbolt's turning latch mechanism 403. Additionally, FIG. 4B illustrates the device 400 being positioned over the deadbolt's locked turning latch mechanism 403 and positioned so that it rests against the door handle 402. As can be appreciated by one skilled in the art, because the lock's turning latch mechanism 403 is affixed with the device 400 and the device 400 is wedged against the door handle 402, it is virtually impossible to turn the turning latch mechanism 403 from outside. In other words, even if someone had a key, they would not be able to unlock the turning latch mechanism 403 of the deadbolt when the device 400 is attached with it. As yet another example, FIG. 4C illustrates the device 400 being attached to a door 401 when a deadbolt's turning latch mechanism 403 and door handle 402 are on the right side of the door 401.

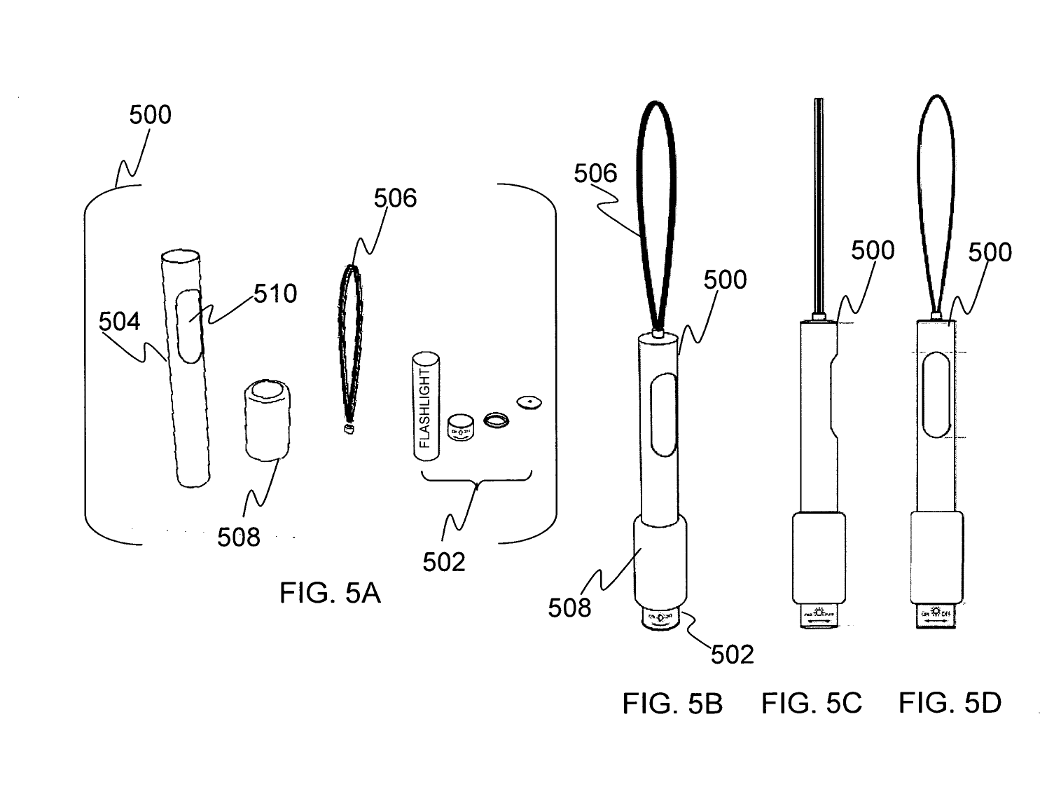

As illustrated in FIGS. 5A through 5D, in order to make the device 500 multi-functional, a flashlight mechanism 502 with an on/off switch may be included in combination with the device 500. As can be appreciated by one skilled in the art, a flashlight mechanism 502 can be attached with the device 500 at any suitable location to provide an additional utility in that a user would have convenient access to a flashlight near a door (or any other suitable location) at all times. As a non-limiting example, the flashlight mechanism 502 is disposed within the elongated rod 504 of the device 500. For instance, if a user wanted to use the flashlight mechanism 502 outside at night, the device 500 could be conveniently removed from its position at the door on the way out. The user could then use the flashlight mechanism 502 of the device 500 in the same manner as a normal flashlight when outside, then return the device 500 to its original position on the way back into the house for later use. An attachment mechanism 506 is provided on the device 500 to allow a user to hang the device 500 from a door handle, lock, or any desired location when not in use, allowing convenient accessibility of the device near the door or other location. A non-limiting example of such an attachment mechanism 506, as shown in FIGS. 5A through 5D, is a strap. This particular attachment mechanism 506 allows a user to hang the device 500 from a desired location when not in use as well as place the device 500 around a user's wrist when the flashlight mechanism 502 function is desired.

As illustrated in FIGS. 5B through 5D, a soft pad 508 is circumferentially disposed around the elongated rod 504. The soft pad 508 provides a means to prevent the device 500 from damaging the door handle when in use. The soft pad 508 can be any suitable material as long as it provides a cushion between the device 500 and the door handle, a non-limiting example of which includes a foam pad. Furthermore, when the flashlight mechanism 502 of the device 500 is in use, the soft pad 508 can be utilized as a gripping portion.

For further illustration, FIG. 5A illustrates the distinct parts of the device 500. The device 500 includes an elongated rod 504 with a latch attachment 510 (e.g., cut-out), a soft pad 508, an attachment mechanism 506 (e.g., strap), and flashlight mechanism 502. FIG. 5B illustrates the device 500 comprised of the parts as shown in FIG. 5A. Additionally, FIG. 5C illustrates a side, perspective of the device 500. A front, perspective-view of the device 500 is shown in FIG. 5D.

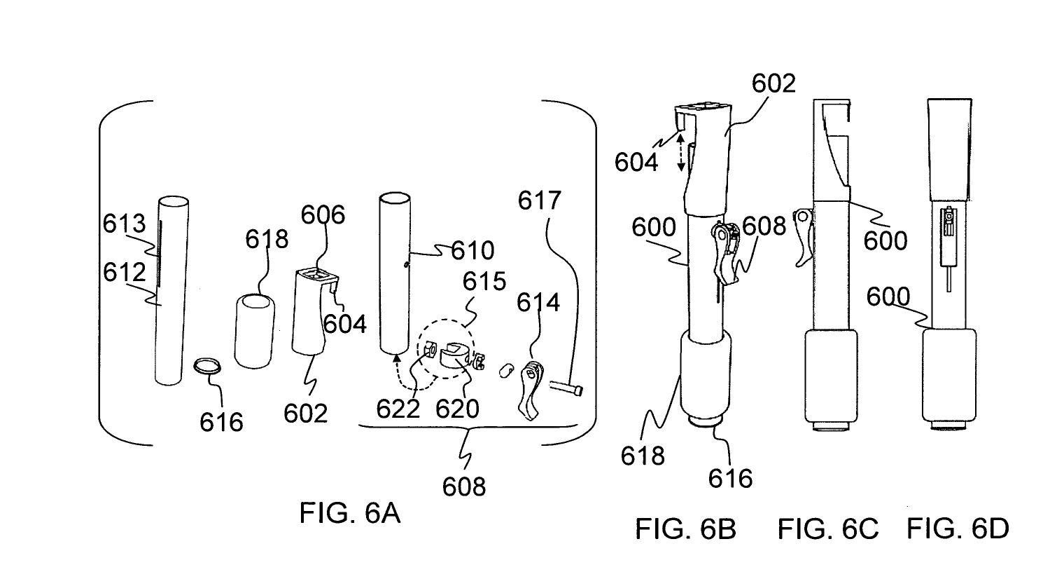

As can be appreciated by one skilled in the art, not all door lock mechanisms are the same. Thus, the present invention also includes additional aspects where the device and corresponding latch attachment are formed to attach with a variety of door lock mechanisms (and their turning latches). For example and as illustrated in FIGS. 6A through 6D, the device 600 is comprised of a latch attachment 602 including a hook device 604 which can be positioned over a turning latch and affixed with door lock mechanisms of a variety of shapes and sizes. The hood device 604 is a dual-pronged hook (with one prong illustrated in FIG. 6A and the other prong illustrated in FIG. 6B) that is formed to flank the turning latch (i.e., door lock mechanism). An opening 606 at the top of the latch attachment 602 allows for the turning latch to be placed therethrough. For instance, when used with a turning latch mechanism of a deadbolt lock, the hook device 604 of the latch attachment 602 slides over the turning latch mechanism, and a portion of the turning latch mechanism can be positioned through the opening 606 at the top of the latch attachment 602, thereby allowing proper attachment of the latch mechanism 602 to the turning latch mechanism of the deadbolt lock.

Additionally, another aspect that contributes to the utility of the device 600 is an adjustment mechanism 608. The adjustment mechanism 608 allows a user to alter the overall length of the device 600 to fit between a given door handle and door lock mechanism. Additionally, the adjustment mechanism 608 is used to effectively clamp the turning latch against the latch attachment 602. The adjustment mechanism 608 is any suitable mechanism or device for adjustably clamping (tightening) the turning latch against the latch attachment 602. As a non-limiting example and as illustrated in FIGS. 6A through 6D, the adjustment mechanism 608 includes an inner rod 610 slidably connected within a hollow elongated rod 612 having a notch 613 therein. Additionally, a positioning device 614 is connected to the inner rod 610 through the notch 613 in the elongated rod 612. A non-limiting example of the positioning device 614 is a clamping lever, as shown. An internal tightening element 615 is positioned within the inner rod 610. The internal tightening element 615 is any suitable element that allows the positioning device 614 to be attached externally with the inner rod 610, a non-limiting example of which includes a cylindrical member 620 and threaded nut 622. Finally, an external tightening element 617 is attached with the positioning device 614 to affix the positioning device 614 with the internal tightening element 615. As a non-limiting example, the external tightening element 617 is a screw that is placed through the positioning device 614, through the notch 613, through the inner rod 610, through the cylindrical member 620 and into the threaded nut 622.

In operation, the positioning device 614 (e.g., clamping lever) is flipped to an open position to release the inner rod 610 from the elongated rod 612, thereby allowing the inner rod 610 to slide along the length of the elongated rod 612 by maneuvering the positioning device 614 along the notch 613 in the elongated rod 612.

Therefore, the inner rod 610 is brought into direct contact with the bottom of the turning latch in order to secure the device 600 between a door handle and turning latch mechanism. When the device 600 is in the desired position with the latch attachment 602 positioned over the turning latch mechanism and the inner rod 610 is in contact with the bottom of the turning latch mechanism (and with the opposite end of the device 600 wedged against the door handle), the positioning device 614 is flipped down to its original position against the elongated rod 612 to affix the inner rod 610 to the elongated rod 612. Hence, the adjustment mechanism 608 allows the device 600 to be positioned between door handles and door lock mechanisms with a variety of lengths therebetween. As can be appreciated by one skilled in the art, the inner rod 610 is not limited to any particular shape, size, or material provided it fits inside the elongated rod 612 sufficiently to perform its designated function.

Alternatively, the inner rod 610 can be reversed to perform the function of the elongated rod 612 while the elongated (outer) rod 612 can be formed to perform the function of the inner rod 610. In other words, the latch attachment 602 can be attached with the inner rod 610 while the elongated rod 612 is slideably adjustable to attach with the turning latch mechanism.

FIG. 6A illustrates the distinct parts of the device 600. As shown, the device 600 includes an elongated rod 612 with a notch 613 therein, a protective cap 616, a soft pad 618 as previously described, a latch attachment 602, and an adjustment mechanism 608 including an inner rod 610 and positioning device 614. Also shown are the internal tightening element 615 and the external tightening element 617. FIG. 6B illustrates the device 600 comprised of the parts as shown in FIG. 6A. For further illustration, FIG. 6C illustrates a side, perspective-view of the device 600. A back perspective-view of the device 600 is shown in FIG. 6D.

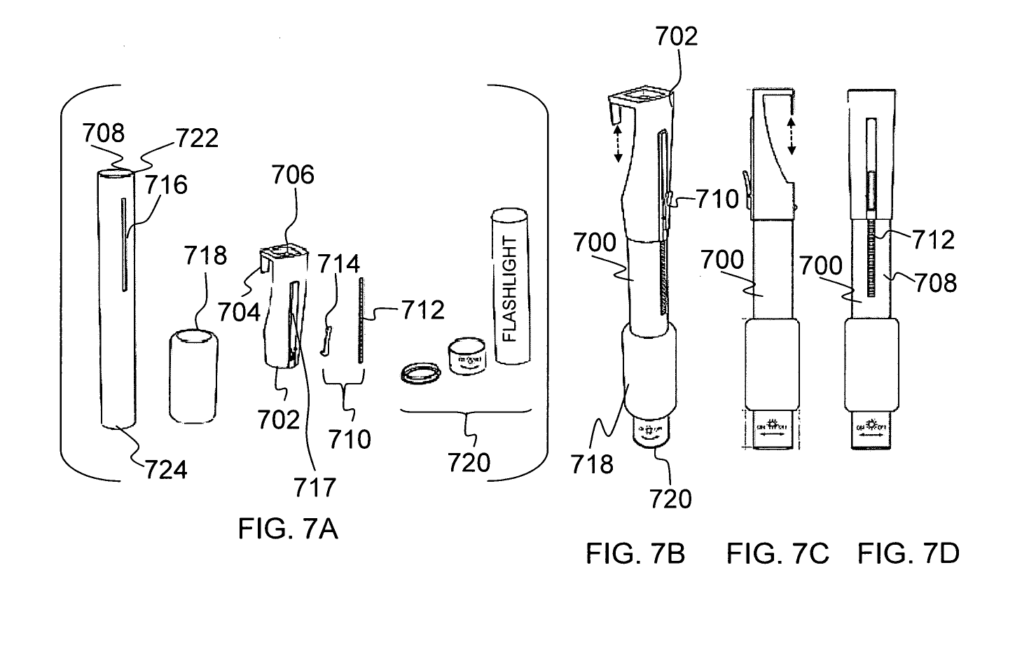

As can be appreciated by one skilled in the art, there are a variety of mechanisms that can be used to attach with a variety of door lock mechanisms and to alter the overall length of the device to fit between a given door handle and the corresponding door lock mechanism. FIGS. 7A through 7D illustrate another aspect of the adjustment mechanism for the device 700. FIG. 7A illustrates the distinct parts of the device 700, including an elongated rod 708, a soft pad 718, a latch attachment 702, an adjustment mechanism 710 (including a notched bar 712 and positioning device 714), and a flashlight mechanism 720. FIG. 7B illustrates the device 700 comprised of the parts as shown in FIG. 7A. For further illustration, FIG. 7C illustrates a side, perspective-view of the device 700. A back, perspective-view of the device 700 is shown in FIG. 7D.

As shown in FIG. 7A, the latch attachment 702 includes a hook device 704 with an opening 706. The latch attachment 702 is slidably connected to an elongated rod 708 with an adjustment mechanism 710. The adjustment mechanism 710 is any suitable mechanism or device for slidably connecting the elongated rod 708 to the latch attachment 702. For example, the adjustment mechanism 710 includes a notched bar 712 and a positioning device 714. A non-limiting example of such a positioning device is a clip with a spring. The elongated rod 708 has a space 716 (e.g., cut-out, notch, or depression) therein for placement of the notched bar 712 of the adjustment mechanism 710. The space 716 is in alignment with a slot 717 in the latch attachment 702. The notched bar 712, in combination with the positioning device 714, slidably connects the latch attachment 702 to the elongated rod 708. Thus, to adjust the length of the device 700 or to affix a door latch mechanism between the latch attachment 702 and the top end 722 of the elongated rod 708, a user depresses the positioning device 714 (which separates it from the notched bar 712) to enable the latch attachment 702 to slide along the notched bar 712 (also illustrated in FIG. 7D). In turn, the latch attachment 702 slides along the length of the elongated rod 708 to bring the latch attachment 702 in contact with and positioned over the turning latch while the top end 722 of the elongated rod 708 is forced against the other side of the turning latch. Additionally, the opposite end 724 of the elongated rod 708 is then wedged against the door handle.

As described previously and as shown in FIGS. 7B through 7D, a soft pad 718 is circumferentially disposed around the elongated rod 708 to prevent the device 700 from damaging the door handle when in use. The soft pad 718 can be any suitable material as long as it provides a cushion between the device 700 and the door handle. In addition, a flashlight mechanism 720 with an on/off switch is included in combination with the device 700. When the flashlight mechanism 720 of the device 700 is in use, the soft pad 718 can be utilized as a gripping portion.

What is claimed is:

1. A device for locking a door, comprising:
an elongated rod; and
a latch attachment disposed on the elongated rod, the latch attachment being formed to be attached with a turning latch of a door lock mechanism, whereby a user can attach the latch attachment with the door lock mechanism and position the elongated rod against a door handle to prevent the lock from being unlocked.

2. A device as set forth in claim 1, further comprising an attachment mechanism affixed with the device for attaching the device with a door when not in use.

3. A device as set forth in claim 2, further comprising a flashlight mechanism disposed within the elongated rod.

4. A device as set forth in claim 3, further comprising a soft pad circumferentially disposed around the elongated rod.

5. A device as set forth in claim 4, wherein the latch attachment is a cut-out formed within the elongated rod, the cut-out being of a suitable size and shape to accommodate a turning latch of the door lock mechanism, whereby a user can position the cut-out over the turning latch and position the elongated rod against a door handle to prevent the lock from being unlocked.

6. A device as set forth in claim 4, wherein the latch attachment further comprises a hook device for attaching the latch attachment with the door lock mechanism.

7. A device as set forth in claim 6, wherein the latch attachment further comprises an opening formed therethrough to allow the turning latch to fit through the opening.

8. A device as set forth in claim 7, further comprising an adjustment mechanism attached with the elongated rod, the adjustment mechanism being formed to allow a user to selectively tighten the latch attachment against the turning latch.

9. A device as set forth in claim 8, wherein the adjustment mechanism further comprises:
an inner rod slidably connected with the elongated rod; and
a positioning device connected with the inner rod to allow the inner rod to be selectively affixed with the elongated rod.

10. A device as set forth in claim 8, wherein the adjustment mechanism further comprises:
a notched bar attached with the elongated rod;
a positioning device formed to interact with the notched bar and connect the latch mechanism to the elongated rod, the positioning device being formed to allow a user to slideably adjust the latch attachment along the elongated rod.

11. A device as set forth in claim 1, further comprising a flashlight mechanism disposed within the elongated rod.

12. A device as set forth in claim 1, further comprising a soft pad circumferentially disposed around the elongated rod.

13. A device as set forth in claim 1, wherein the latch attachment is a cut-out formed within the elongated rod, the cut-out being of a suitable size and shape to accommodate a turning latch of the door lock mechanism, whereby a user can position the cut-out over the turning latch and position the elongated rod against a door handle to prevent the lock from being unlocked.

14. A device as set forth in claim 1, wherein the latch attachment further comprises a hook device for attaching the latch attachment with the door lock mechanism.

15. A device as set forth in claim 1, wherein the latch attachment further comprises an opening formed therethrough to allow the turning latch to fit through the opening.

16. A device as set forth in claim 1, further comprising an adjustment mechanism attached with the elongated rod, the adjustment mechanism being formed to allow a user to selectively tighten the latch attachment against the turning latch.

17. A device as set forth in claim 16, wherein the adjustment mechanism further comprises:
an inner rod slidably connected with the elongated rod; and
a positioning device connected with the inner rod to allow the inner rod to be selectively affixed with the elongated rod.

18. A device as set forth in claim 16, wherein the adjustment mechanism further comprises:
a notched bar attached with the elongated rod;
a positioning device formed to interact with the notched bar and connect the latch mechanism to the elongated rod, the positioning device being formed to allow a user to slideably adjust the latch attachment along the elongated rod.

19. A method for forming a device for locking a door, comprising an act of disposing a latch attachment on an elongated rod, the latch attachment being formed to be attached with a turning latch of a door lock mechanism, whereby a user can attach the latch attachment with the door lock mechanism and position the elongated rod against a door handle to prevent the lock from being unlocked.

20. A method as set forth in claim 19, wherein in the act of disposing a latch attachment on an elongated rod, the latch attachment includes a hook device for attaching the latch attachment with the door lock mechanism.

21. A method as set forth in claim 20, wherein in the act of disposing a latch attachment on an elongated rod, the latch attachment includes an opening formed therethrough to allow the turning latch to fit through the opening.

22. A method as set forth in claim 19, further comprising an act of disposing a flashlight mechanism within the elongated rod.

23. A method as set forth in claim 19, wherein in the act of disposing a latch attachment on an elongated rod, the latch attachment is formed as a cut-out within the elongated rod, the cut-out being of a suitable size and shape to accommodate a turning latch of the door lock mechanism, whereby a user can position the cut-out over the turning latch and position the elongated rod against a door handle to prevent the lock from being unlocked.

24. A method as set forth in claim 19, further comprising an act of attaching an adjustment mechanism with the elongated rod, the adjustment mechanism being formed to allow a user to selectively tighten the latch attachment against the turning latch.

25. A method for locking a door, comprising acts of:
connecting a latch attachment with a turning latch of a door lock mechanism, the latch attachment being connected with an elongated rod; and
positioning the elongated rod against a door handle to prevent the door lock mechanism from being unlocked.
